(19) United States
(12) Patent Application Publication
(10) Pub. No.: US 2026/0223790 A1
(43) Pub. Date: Aug. 6, 2026

(54) ARTIFICIAL RAIN PRODUCING TECHNOLOGY PREVENTING GLOBAL WARMING AND CONTROLLING POLLUTION

(71) Applicants: Parshottambhai PIPALIYA, Surat, Gujarat (IN); Varshaben PIPALIA, Surat, Gujarat (IN); Jignesh PIPALIYA, Surat, Gujarat (IN)

(72) Inventors: Parshottambhai PIPALIYA, Surat, Gujarat (IN); Varshaben PIPALIA, Surat, Gujarat (IN); Jignesh PIPALIYA, Surat, Gujarat (IN)

(21) Appl. No.: 19/147,758

(22) PCT Filed: Jan. 11, 2024
(86) PCT No.: PCT/IN2024/050028

§ 371 Date: Jul. 14, 2025

(30) Foreign Application Priority Data
Jan. 16, 2023 (IN) 202321003101

(51) Int. Cl. A01G 15/00

(52) U.S. Cl. CPC A01G 15/00

(57) ABSTRACT

The present invention relates to an artificial rain producing technology which makes the use of the humidity in the air to produce artificial rain. Air containing 15% to 100% humidity is transferred through suction pipes and flexible pipes to air mixers which are stationed at a height where the temperature of the atmosphere is between 0° C. to 5° C. or any other condensing temperature so that the water vapour containing air mixes with the atmospheric air of low temperature and condenses the water vapour to form water droplets and fall down on the earth in the form of artificial rain. The flexible pipe and the air mixer assembly is stationed in the air with the help of helicopters which can move the assembly to a location where rainfall is desired. Rainfall when produced prevents global warming and controls pollution.

### FIELD OF THE INVENTION

The present invention relates to an artificial rain producing technology which involves artificially condensing the water vapour present in the air and converting into rain. This technology for producing rain being environment friendly, controls pollution and prevents global warming.

### BACKGROUND OF THE INVENTION

Water is the basic requirement for life on earth. All living things including humans, animals, plants etc. require water for their growth and survival. The main sources of water are rain, ground water, ice, rivers, lakes, streams etc. Rain is one of the important sources of water and is a major component of the water cycle which deposits the maximum amount of fresh water on the earth. Due to the heat of the sun, water from the water bodies of the earth gets converted to water vapour which rises in the air and forms clouds in which this water vapour condenses to form water (due to the cool temperature) which falls back on the earth in the form of rain. However many regions in the world (countries like Israel, U.A.E., Kuwait, Abu Dhabi, Saudi Arabia, Oman, Qatar and some regions of South Africa and USA) receive very little or no rainfall leading to problems like drought and water scarcity. This may be due to one or more among increased human consumption, overuse, wastage, urbanization, deforestation, climate change, increased population, pollution, industrialization etc.

Scientists and researchers have worked for decades to produce artificial rain to combat water scarcity and drought conditions. One of the technologies developed by scientists is cloud seeding. Cloud seeding is a type of water modification that aims to change the amount or type of precipitation that falls from clouds by dispersing substances into the air that serve as cloud condensation or ice nuclei. Mostly either dry ice or more commonly, silver iodide aerosols are spread into the upper part of the clouds to try to stimulate the precipitation process and form rain. The clouds are sprayed with chemicals using aeroplanes to condense smaller particles into larger rain droplets. Cloud seeding increases rainfall rates by 10% to 30% per year. However it has a number of side effects:
The chemicals used in cloud seeding might be potentially harmful to plants, animals, humans and/or environment.
Cloud seeding might change the climatic patterns of our planet.
The process is expensive as it involves delivering chemicals to the sky to release them by flare shots or aeroplanes.
The chemicals used in cloud seeding will pollute the environment.

Along with cloud seeding, a number of technologies related to artificial rain, have been invented in the prior art:

US2022357482 describes a method and system of analyzing ingredients of an artificial rainfall for verification of a cloud seeding effect. As the method and system, which can verify an effect of the artificial rainfall in such a manner that a seeding material becomes different according to each temperature of clouds at a seeding altitude, water sampling from precipitation is performed before and after seeding, and thus the ingredients of a water sample are analyzed using each of a method of analyzing a heavy metal component and a method of analyzing a water-soluble ion component according to a cool cloud and a warm cloud so that whether or not there is a change in each concentration of the ingredients can be determined, are provided, an experiment for the artificial rainfall can more effectively be performed.

NL2030188 discusses an artificial rainfall simulation device composed by multiple nozzles and units, 5 which comprises a water reservoir, a water pipe, a water pump, a steel pipe upright, a fan, a movable component, a rain sprinkler and a multi-layer steel pipe transverse column assembly; one end of the water supply pipeline is connected to a reservoir, and the other end of the water supply pipeline is connected to a water pump; one end of the steel pipe upright is connected to a water pump, and the other end of the steel pipe upright is provided with a multi-layer steel pipe 10 transverse column assembly at intervals; the steel pipe upright is movably connected to the steel pipe transverse column assembly through a movable component; the steel pipe transverse column assembly comprises a plurality of steel pipe transverse columns; a plurality of rain sprinklers are arranged on the steel pipe transverse column; a fan is also arranged on the steel pipe upright, and the air outlet of the fan is opposite to the rain sprinkler. The invention is simple 15 in structure and easy to operate, which not only reduces the experiment cost, increases the application range of the experiment, but also makes the rainfall experiment simpler, and makes use of the movable components and fans to finely simulate the rain intensity and the direction of raindrops, thus improving the fitting effect to the actual rainfall process.

JP2022120741 discloses an artificial rainfall suppression method in which cobalt oxide (II) nanoparticles are sprayed from above a cloud being irradiated with sunshine so as to eliminate the cloud.

GR900100007 relates to a new system for extinguishing forest fires, mounted mainly on appropriately constructed helicopters (fire-extinguishing helicopters), as these are generally described, which will be able to control and then put out, entirely and efficiently, any forest fire. The fire-extinguishing helicopters will have holders for portable water tanks with their sprinklers (water jets) that will create artificial rain within an appropriate radius in a stable position, the one next to the other, over the fire. These helicopters can also have holders for different equipment mechanisms. When they are appropriately constructed to act as transport helicopters, they will be able to play a complex defensive role during conventional wars of a country. With that exception, the system will be used exclusively as a forest fire-extinguishing system.

CN 217110688 describes an explosive pressing structure of artificial rainfall bomb which structurally comprises a wind explosion expansion grain, a first-stage grain, a second-stage grain, an artificial rainfall agent, a third-stage grain and a fourth-stage grain, the inside of the bomb body is filled with explosives for the first time to form the fourth-stage grain, and then the upper end of the fourth-stage grain is filled with the second-stage grain to be pressed into the third-stage grain. Then, an artificial rainfall agent is placed on the third-level grain, then the explosive is pressed at the upper end of the third-level grain to form a second-level grain, finally, fourth filling is conducted to form a first-level grain, and an explosion expansion grain is placed in a groove in the first-level grain, so that potential safety hazards in the explosive pressing process and the explosion suppression effect of the artificial rainfall agent are reduced; and the consistency of the internal explosive structure can be guaranteed, and fragments with small mass are formed after explosion.

CN217184099 discusses a portable artificial rainfall device which comprises a base, the left side and the right side of the top of the base are each fixedly connected with two vertical frames, the tops of the vertical frames are fixedly connected with a combustion furnace body, the top of the base is fixedly connected with a side frame, and the side frame is fixedly connected with a bottom plate. A side limiting frame is fixedly connected to the right side of the side frame, a rotating hollow pipe is connected to the left side of the side frame through a bearing, and a positioning plug pin with one end sequentially penetrating through the rotating hollow pipe and the side limiting frame and extending into the side limiting frame is movably connected to the top of the rotating hollow pipe. A rotating rod is fixedly connected to the left side of the rotating hollow pipe, a rocker is fixedly connected to the end, away from the rotating hollow pipe, of the rotating rod, driving conical wheels are fixedly connected to the left side and the right side of the outer side of the rotating rod, and driven conical wheels are engaged with the bottoms of the driving conical wheels. The portable artificial rainfall device integrally achieves the purpose of high portability.

CN217250077 discloses an artificial rainfall simulation device. The device comprises a bracket, a liftable platform, a water storage tank and a rotatable spray head, the liftable platform comprises a flat plate and small winches, the supports are arranged in a bilateral symmetry mode, the flat plate is located between the left support and the right support, the winches are symmetrically installed on the supports, and the free ends of steel cables are connected with the flat plate, so that the flat plate is kept horizontal and can ascend and descend vertically between the supports on the two sides. The water storage tank is fixed on the flat plate, a certain gap is reserved between the water storage tank and the flat plate, the rotatable spray heads are arranged on the flat plate in an array mode, and each spray head is independently communicated with the water storage tank; and the rotatable spray head is driven by a motor to rotate around a horizontal rotating shaft and a vertical rotating shaft respectively. According to the utility model, the water outlet height, the water outlet direction and the water outlet amount of the nozzle can be adjusted simultaneously, so that rainfall under various conditions can be simulated more accurately.

IN355/MUM/2006 quotes that after lighting, precipitation is formed by endothermic reactions in the atmosphere. It is proved by indirect evidences with scientific calculation on paper and also practically in laboratory scale. This natural lightning phenomenon can be used for artificial rainmaking by creating artificial lightning in the upper atmosphere and triggering natural lightning phenomena to leading endothermic reactions in between Nitrogen and oxygen molecules in the atmosphere; condensation takes place on to CCN in cloud parcel and enhancing precipitation in the atmosphere after artificial lighting. For Artificial Rain making, by using high power intensity LASER BEAM through air-craft in the atmosphere, which is creates artificial lighting in upper atmosphere, for triggering natural lightning phenomena and natural sequence occur in the atmosphere Artificial lightning creates high temperature, at high temperature bonds of Nitrogen and oxygen break out to active (N) and active (O) N2®[N][N]O2 ®[O][O] These active (N) and active (O) reacts to each other and formed NO and O3 in the atmosphere. N2+O2+M=2NO-Dh (Dh=43200 Cal/mol) O2+1/2 O2+M=O3--Dh (Dh=67600Cal/mol) Formation of NO and O3; at that time, endothermic process start; these endothermic process required large amount of heat energy which is abstract form surrounding atmosphere clouds; Means these formation of NO and O3 reactions; absorbs large amount of heat energy from surrounding atmosphere clouds; condensation takes place on to CCN in cloud parcel. Small water droplets are formed in upper atmosphere; chain of water droplets formation starts in the atmosphere; enhancing rain drops; results in to artificial rain making.

IN201621035567 provides an innovative ground operated artificial rainfall device. It is a novel and unprecedented device which continuously generates charged intermediate negative ions from ground station for ionizing the atmosphere to locally modify the atmosphere to get artificial rainfall system. The shape, geometry of electrodes and generation of intermediate negative ions with enough acceleration so as to overcome strong horizontal winds to reach boundary layer and above is designed. Ionized air flow of velocity nearly equal to 2 m/s from 0.01 m/s of air is achieved. Experiments are performed on this device in open atmosphere. The spike electrode is given −30kV and below negative voltage from a power supply. The Ion counter is used to measure the number of ions. Generation of continuous ionized flow of nearly 10×1O6 ions/cm³ as against 750-800 ions/cm³ naturally existing ions is achieved at the boundary layer. These ions catalyse the precipitation process to get artificial rain.

IN202121041395 relates to implementation of artificial intelligence for artificial rainmaking through laser initiation endothermic reactions through drone remote control system. The mega UAV fitted with pen tax digital camera is used for taking high resolution images on demand. Mega UAV is controlled by autopilot along with pre-programmed ground control software or can be manually taken off using simple joy stick working at radio frequency range. To trigger ionization process UAV is equipped with plasma frequency releasing system and is sent to the inner of the cloud mass density. UAV system goes deep inside the cloud mass and releases single high power LASER pulse in atmosphere. Drone systems are used to create acceleration and turbulence by wind force and tiny water particles collides and becomes bigger rain drops. Such bigger rain drops acts as seed to form another rain drops and raining occurs. Sending the UAV to cloud helps to avoid chances of coming natural lightening to ground and chances of damage to livings can be optimized.

Although a number of artificial rain producing technologies are available in the prior art, most of them involve the use of chemicals, large quantities of water (to be sprinkled as rain), heat, huge volumes of electricity, specially designed electrodes, aeroplanes and helicopters to carry large loads and at some places rockets. All these requirements are quiet expensive and cause harm to the environment thereby increasing the pollution level as well as global warming. Moreover most of these technologies do not guarantee rainfall. Hence an artificial rain producing technology, which does not involve the use of chemicals and which uses natural processes for producing rainfall artificially, is the need of the day.

### OBJECT OF THE INVENTION

The main object of the invention is to provide artificial rain producing technology preventing global warming and controlling pollution which uses the water vapour present in the air to produce artificial rain.

Another object of the invention is to provide artificial rain producing technology preventing global warming and controlling pollution which condenses the water vapour in the air and converts it into water to produce artificial rain.

Still another object of the invention is to provide artificial rain producing technology preventing global warming and controlling pollution which doesn't involve the use of any kind of chemicals or ions making the technology environment friendly thereby controlling pollution. Yet another object of the invention is to provide artificial rain producing technology preventing global warming and controlling pollution which produces the desired quantity of rain at the desired locations thus preventing the increase in temperature of the earth and reducing global warming.

A further object of the invention is to provide artificial rain producing technology preventing global warming and controlling pollution which is economical.

### SUMMARY OF THE INVENTION

The present invention describes an artificial rain producing technology preventing global warming and controlling pollution which involves the suction of air containing water vapour into pipes with the help of blowers. This water vapour is transferred above through flexible pipes, which are held in the air, at a high altitude, with the help of helicopters. Air mixers are present at the upper end of the flexible pipes which have small holes through which the water vapour containing air passes, causing condensation of the vapour. The air then escapes into the atmosphere at a high altitude, through the small holes of the air mixer wherein the air coming out becomes cool and the water vapour coming out gets converted into water due to the low temperature and is showered on the earth in the form of artificial rain.

### BRIEF DESCRIPTION OF THE DRAWINGS

FIG. 1 gives the drawing displaying the suction of the air containing water vapour from over the sea and sending it to higher altitude for condensation.

FIG. 2 gives the drawing displaying the suction of the air containing water vapour from land and sending it to higher altitude with the support of hills, for condensation.

FIG. 3 gives the drawing displaying the suction of the air containing water vapour from the land and sending it to higher altitude for condensation.

FIG. 4 gives the complete drawing of the air mixer.

FIG. 5 gives the specification of the high pressure centrifugal blower with motor used.

### DETAILED DESCRIPTION

The nature of the invention and the manner in which it is performed is clearly described in the specification. The invention has various components and they are clearly described in the following pages of the complete specification.

Almost 3 parts of the earth's surface is water and 1 part is land. The heat of the sun evaporates the water from the seas, lakes and reservoirs to form water vapour which remains present in the air and rises in the air. Humidity is the amount of water vapour present in the atmosphere. The humidity level of different geographical locations is different, depending upon its proximity to water bodies. Usually, the humidity level at any place on the earth, is between 20% to 100%. Atmosphere having 70% to 100% humidity is considered as very good humidity atmosphere, atmosphere having 45% to 70% humidity is considered as medium humidity atmosphere and atmosphere having 20% to 45% humidity is considered as normal humidity atmosphere. The more the humidity of a region, the greater quantity of rainfall it experiences. The level (altitude) of all places on the earth is measured from sea-level (0.0 m). Humidity is found in the atmosphere maximum uptill the height of 20,000 meter±3000 meter above the surface of the earth. This water vapour condenses and converts into water, causing rain.

The earth's atmosphere varies at almost every 250 meters above the earth's surface by approximately 2 degree centigrade. So at every 1 kilometer distance, the temperature decreases by 6 to 7 degrees. For eg. if the temperature at the earth's surface is 35° C., it will be approximately 28° C., 1000 meters above the earth's surface, 21° C., 2000 meters above the earth's surface, 14° C., 3000 meters above the earth's surface, 7° C., 4000 meters above the earth's surface and 0° C., 5000 meters above the earth's surface. The temperature required for conversion of water vapour to water is 0°to 5° C. Hence the water vapour which is formed at a temperature of 35° C. at sea level, needs to rise 4-5 kilometers high, to get converted into water droplets and cause rainfall.

The present invention describes an artificial rain producing technology preventing global warming and controlling pollution, which captures the air containing water vapour into pipes, raises it to the required height and condenses it such that the water vapour gets converted into water and falls on the earth to produce artificial rain.

In the technology of the present invention, humid air (with 20% to 100% humidity) is sucked from the surface of the earth (at sea level, above sea level or below sea level) in suction pipes with the help of A.C./D.C. blower with motors, above the platform and sent to the outlet pipes. The outlet of these outlet pipes (which are assembled over the platform) is connected to the inlet of flexible pipes which are very long. These flexible pipes are made of any among aerogel, lightweight PVC, silica carbon, aluminium, pyrogenic silica or any similar material, which are insulating materials or coated with an insulating material. The weight of these materials is very less. For example weight of aerogel is very near to the weight of air. Moreover one cubic inch of aerogel can be spread out to cover an entire football field. As it is a strong, durable and thin material, it can be used to make the lightweight flexible pipes of greater lengths. The length of these flexible pipes is determined depending upon the temperature at the surface of the earth and the distance the humid air needs to travel to reach cooler temperatures where the water vapour in the air gets converted into water by condensation. The outlet of these flexible pipes is joined to the air mixer which has small holes on its surface. Cold air from the outside (at the higher altitude) enters the air mixer through the holes and mixes with the humid air of the earth's surface, entering the air mixer from the flexible pipe, and condenses the humid air. Due to this the water vapour in the air cools down to form water droplets and falls on the earth as artificial rain. The air mixer is tied to the helicopter with a rope due to which the arrangement, right from the inlet of the flexible pipes to the outlet of the air mixer, can be moved with the help of the helicopter such that rain can fall at the desired location on the surface of the earth. in 5 The present invention can be assembled at different kinds of locations in different manners, few of which are explained in the following examples:

### Example 1: Suction of Air Containing Water Vapour From the Sea/Ocean/Lake Regions

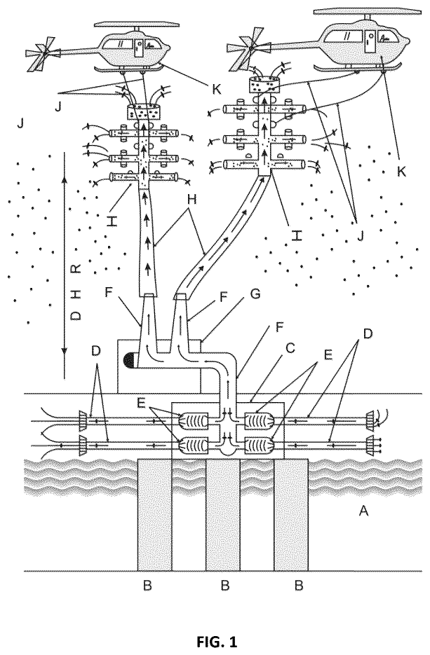

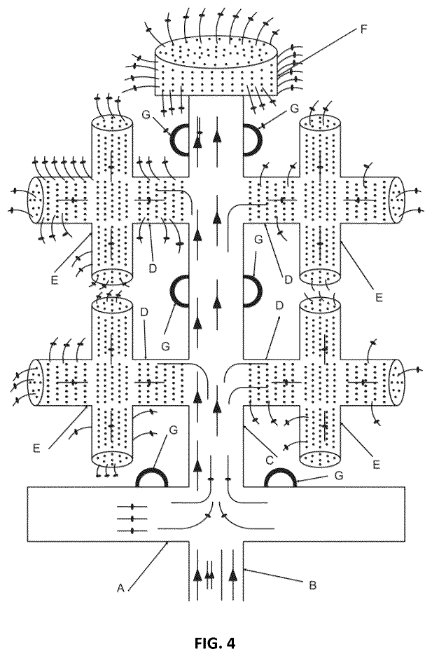

As shown in FIG. 1, when artificial rain needs to be produced near sea/ocean/lake regions (A), a sea rain platform stand (B) is mounted in the water body from the bottom of the sea on which are mounted inlet suction pipes (D). Over the stand (B) is a platform (C) which is at the upper level of water. This platform supports the suction pipes and the 75 hp, 54.4 KW A.C./D.C. blowers (E) with motor. The power consumption of the 75 hp blower is 56 units/hour at full load. These A.C./D.C. blowers (E) increase the amount of air containing water vapour being sucked into the suction pipe (D) at high pressure or low pressure. The rate of suction of water vapour containing air is 30,000 cubic meters per hour. The inlet suction pipes (D) and the blowers (E) are connected to the outlet pipe (F) through which the air sucked in with the help of blowers, passes. Another platform (G) is assembled on the earth level near the water body, through which the outlet pipe (F) passes. To the outlet pipe (F), is connected the 5 mm thick long outer pipe (H) of 12 inch diameter, which is made of flexible, lightweight, pressurized material, of the required size, wherein the outlet of this flexible pipe (H) is connected to the air mixer unit (I). The air mixer unit (I) is described in detail in FIG. 4. It has holes through which cold air from the atmosphere at higher altitudes enters and mixes with the water vapour containing air which has travelled from near the water body to the high altitude through the pipes (D), (F) and (H). The cold air condenses the water vapour in the air travelled from the water body, to produce artificial rain. The rate of discharge from the flexible pipe is 30,000 cubic meters per hour. The air mixer (I) is connected to a helicopter (K) of the required capacity with the help of a rope (J). This helicopter (K) ensures that the flexible outer pipe connected to the air mixer, is stationed at a position such that the artificial rain produced falls at the desired place. DHR is the distance required by the water vapour containing air to travel, to reach at an altitude where the temperature is between 0° C. to 5° C., or at any condensing temperature, such that the water vapour condenses to produce water droplets and falls on the earth in the form of artificial rain. This distance may be anywhere among sea level at 0.0 meters, below the sea level till 500±200 meters below and above the sea level till 1000 meters high. The length of the flexible pipe is determined depending upon the distance required for the air to travel, for condensation.

### Example 2: Suction of Air Containing Water Vapour from Land Area Near the Hills/Mountains

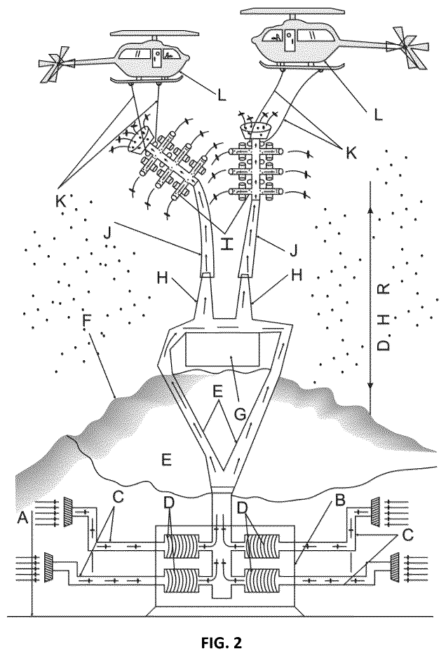

When artificial rain needs to be produced over a land region which has hills/mountains nearby, the arrangement of the present invention is done as displayed in FIG. 2. A platform (B) is built on land (A) on which are assembled the inlet (C) of the suction pipes and the 75 hp, 54.4 KW A.C./D.C. blower with motor (D). The power consumption of the 75 hp blower is 56 units/hour at full load. These A.C./D.C. blowers (D) increase the amount of air containing water vapour being sucked into the suction pipe (C) at high pressure or low pressure which air sucked at a rate of 30,000 cubic meters per hour is sent to the outlet pipes. The outlet pipes (E) are either made of insulating materials or coated with insulating material and are supported on the hill/mountain (F), which travel to the top of the hill/mountain (F) throughout its height. These pipes may travel over the surface of the hill/mountain or under the surface of the hill/mountain. A platform (G) is built on the top of the hill/mountain (F) on which the outlet pipe is brought. The outlet pipe (H) stands on the top of the platform (G). To the outlet pipe (H) is joined the air mixer unit (I) with the help of 12 inch dimeter flexible pipe (J), which is made of 5 mm thick flexible, lightweight, pressurized material, of the required size. The length of the flexible pipe is dependent on the height of the hill/mountain and the length the air containing water vapour needs to travel to reach 0° C. to 5° C. temperature region or at any condensing temperature so that the water vapour in the air present in the pipes condenses to form water droplets which fall down in the form of rain. The air mixer unit (I) is described in detail in FIG. 4. It has holes through which cold air from the atmosphere at higher altitudes enters and mixes with the water vapour containing air which has travelled from near the hill/mountain to the high altitude through the outlet pipes and the flexible pipes. The cold air condenses the water vapour in the air travelled from the land area, to produce artificial rain. The rate of discharge from the flexible pipe is 30,000 cubic meters per hour. The air mixer (I) is connected to a helicopter (L) of the required capacity with the help of a rope (K). This helicopter (L) ensures that the flexible outer pipe connected to the air mixer, is stationed at a position such that the artificial rain produced falls at the desired place. DHR is the distance required by the water vapour containing air to travel, to reach at an altitude where the temperature is between 0° C. to 5° C., or at any condensing temperature, such that the water vapour condenses to produce water droplets and falls on the earth in the form of artificial rain. This distance, as the pipes travel in an inclined manner due to the inclination of the hill/mountain, may be anywhere among sea level at 0.0 meters, below the sea level till 500±200 meters below and above the sea level till 1000 meters high above the hills/mountains. The length of the flexible pipe is determined depending upon the distance required for the air to travel, for condensation.

### Example 3: Suction of Air Containing Water Vapour From Land

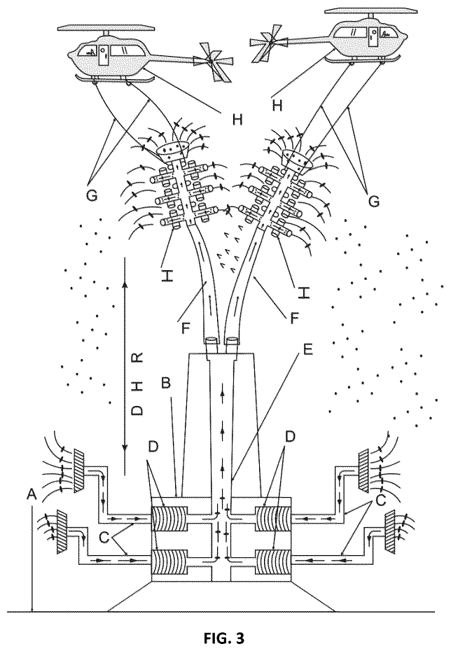

When artificial rain needs to be produced over a land region which does not have any water bodies or hills/mountains nearby, which region may be at the sea level or below the sea level, the arrangement of the present invention is done as displayed in FIG. 3. A platform (B) is built on land (A) on which are assembled the inlet (C) of the suction pipes and the 75 hp, 54.4 KW A.C./D.C. blower with motor (D). The power consumption of the 75 hp blower is 56 units/hour at full load. These A.C./D.C. blowers (D) increase the amount of air containing water vapour being sucked into the suction pipe (C) at high pressure or low pressure. The rate of suction of water vapour containing air is 30,000 cubic meters per hour. The air containing the water vapour passes through the suction pipes and the blower and then through the outlet pipes (E) which pass through a high stand built on the platform (B). To the outlet pipe (E) is joined the air mixer unit (I) with the help of 5 mm thick flexible pipe (F), having a diameter of 12 inches, which is made of flexible, lightweight, pressurized material, of the required size. The height of the flexible pipe is dependent on the length the air containing water vapour needs to travel to reach 0° C. to 5° C. temperature region or at any condensing temperature so that the water vapour in the air present in the pipes condenses to form water droplets which fall down in the form of rain. The air mixer unit (I) is described in detail in FIG. 4. It has holes through which cold air from the atmosphere at higher altitudes enters and mixes with the water vapour containing air which has travelled from the land to the high altitude through the outlet pipes and the flexible pipes. The cold air condenses the water vapour in the air travelled from the land area, to produce artificial rain. The rate of discharge from the flexible pipe is 30,000 cubic meters per hour. The air mixer (I) is connected to a helicopter (H) of the required capacity with the help of a rope (G). This helicopter (H) ensures that the flexible pipe connected to the air mixer, is stationed at a position such that the artificial rain produced falls at the desired place. DHR is the distance required by the water vapour containing air to travel, to reach at an altitude where the temperature is between 0° C. to 5° C., or at any condensing temperature, such that the water vapour condenses to produce water droplets and falls on the earth in the form of artificial rain. This distance may be anywhere among sea level at 0.0 meters, below the sea level till 500±200 meters below and above the sea level till 1000 meters high. The length of the flexible pipe is determined depending upon the distance required for the air to travel, for condensation.

FIG. 4 gives the complete diagram of the air mixer (A) whose main function is to mix the low pressure or high pressure air containing water vapour sucked from below with the cold air entering the air mixer from the outside environment through the holes in the mixer pipe. As shown in the figure, the air mixer (A) is connected to the flexible pipes with the inlet connection (B). The air containing the water vapour, sucked in from below, passes through the main outlet pipe (C) of the air mixer. This main outlet pipe (C) is joined to the sub-joint pipe (D) of the air mixer (A) which sub-joint pipe has mini sub-joint pipe (E) as its part. The sub-joint pipes (D) and the mini sub-joint pipes (E) have holes on its surface through which air from the outer atmosphere enters the air mixer. The mixed air flows out of the complete arrangement through the air mixer outlet (F), where the water vapour condenses to form water droplets and falls on the earth's surface in the form of artificial rain. The air mixer (A) has supports (G) at various locations on its main pipe for connecting the air mixer to the helicopter with ropes.

The air mixer is very light in weight and is made of P.V.C. material. The length and diameter of the pipe can be 10 mm, 100 mm, 1000 mm or more according to the requirement. This pipe is made of hard and strong material which can handle high pressure. When a rope is tied to the support (hook) of the air mixer and the other end of the rope is tied to the hook on the helicopter, the flexible pipe along with the air mixer can be moved and raised to the desired height such that the water vapour condenses to cause rainfall. More than one air mixers can be fitted to each flexible pipe according to the requirement.

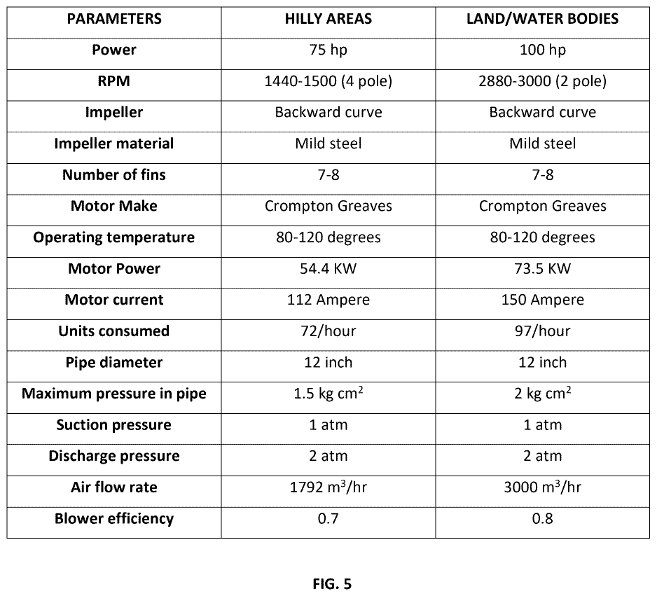

In all the three examples mentioned above, the A.C./D.C air blowers used in the present invention are joined with motors for which the required proportion can be 1 H.P. to 500, 1000 . . . 1 or 2, 3, 4, 5 etc. depending on the air containing water vapour, which may be at low pressure or high pressure. The specifications of exemplary high pressure centrifugal blower with motor which can be used for transferring the air containing water vapour from the land/water bodies/hilly areas to the air mixers has been provided in the table displayed in FIG. 5. In each of these systems, the air with water vapour is sucked from lower level and transferred to the condensing climate at the upper level in the direction in which the winds are blowing so that the rain falls in that direction. Rain can also be made to fall in the direction opposite to the direction of the wind. The technology of the present invention can cause rainfall in an area of approximately 5.0 to 10.0 kilometers or 3.108 to 6.215 miles.

The flexible pipes described in the present invention can be replaced by any other stationary or moving structure like tower or similar structure which aids in transferring the water vapour to cooler climate so that the water vapour condenses to water and falls on the earth in the form of rain and the requirement of helicopter for holding the flexible pipes and air mixers assembly in the air, may be removed.

The artificial rain producing technology of the present invention is highly advantageous as it helps in solving the water problem in places which receive less or negligible rainfall. As rain can be produced whenever and wherever required using the technology of the present invention, agriculture will benefit and the green cover on the earth will increase. This will lead to reduced global warming as the temperature of the earth will gradually reduce due to sufficient amount of rainfall. Moreover the present invention does not involve the use of any kinds of chemicals for producing artificial rain due to which the pollution caused by using chemicals (like in cloud seeding technology), will decrease. The assembly of the present invention can be built in places where forest fires frequently break out. The artificial rain produced can help extinguish forest fires. As the present invention uses the water vapour present in the atmosphere of the earth as the main component to produce artificial rain, the system can be built anywhere on the earth because the only requirement for the technology to work is that the humidity in the atmosphere should be between 15% to 100% (which is commonly seen on most places of the earth). Using the present invention, artificial rainfall can be produced in all regions, at sea level, below sea level and above sea level. Moreover the cost required for installation and working of the artificial rainfall producing technology of the present invention is quiet less compared to the technologies available in the prior art and the hoards of benefits achieved, making the artificial rain producing technology of the present invention very economical.

Although the preferred embodiment as well as the construction and use have been specifically described, it should be understood that variations in the preferred embodiment could be achieved by a person skilled in the art without departing from the spirit of the invention. The invention has been described with reference to specific embodiments which are merely illustrative and not intended to limit the scope of the invention as defined in the claims.

1. Artificial rain producing method which involves the use of water vapour present in the atmosphere to produce rain artificially characterized by platforms installed either at sea level or above sea level or below sea level, arrangement of suction pipes, A.C./D.C. blowers with motors
outlet pipes, long flexible pipes made of strong lightweight material;
air mixers with
holes present on the surface and helicopter with ropes to hold the flexible pipes upright in the air;
wherein the method for producing rain artificially involves the following steps:
(i) suction of water vapour containing air into the suction pipes present on the platform with the help of A.C./D.C. blowers with motor;
(ii) passage of the water vapour containing air from the outlet pipe to the inlet of the long flexible pipes;
(iii) travelling of the water vapour containing air through the length of the flexible pipes to reach the atmosphere having condensing temperature;
(iv) passage of the water vapour containing air from the outlet of the flexible pipe into the air mixers through its inlet which air mixers have holes through which the cold air from the atmosphere enters the air mixer and mixes with the water vapour containing air which has been sucked up with the help of suction pipes and flexible pipes; and
(v) condensation of the water vapour present in the air mixer by mixing with the cold air and formation of water droplets, which fall down on the earth in the form of artificial rain.

2. The artificial rain producing method as claimed in claim 1 wherein when water vapour containing air is to be sucked from sea/ocean/lake regions, a platform stand (B) is mounted in the water body (A) on which are mounted inlet suction pipes (D) which are supported on the platform (C) built on the platform stand (B);
wherein the suction pipes (D) are provided with A.C./D.C. blowers (E) with motors which increase the amount of air containing water vapour being sucked in the suction pipes (D) at high pressure or low pressure;
wherein the inlet suction pipes (D) and the blowers (E) are connected to the outlet pipe (F) through which the air sucked in passes;
wherein another platform (G) is assembled on the earth level near the water body through which the outlet pipe (F) passes;
wherein a long flexible outer pipe (H) is connected to the outlet pipe (F) which is made of lightweight pressurized material;
wherein the air containing water vapour from the outlet pipe (F) passes through the flexible outer pipe (H);
wherein the outlet of the flexible outer pipe (H) is connected to the air mixer unit (I) which has holes over its surface;
wherein cold air from the atmosphere enters the air mixer unit (I) through the holes and mixes with the air containing water vapour, condensing it to form water droplets which fall out from the air mixer (I) towards the ground in the form of artificial rain; and
wherein the air mixer (I) is connected to a helicopter (K) with the help of a rope (J) to station the flexible outer pipe (H) and air mixer (I) assembly at a position where rainfall is desired.

3. The artificial rain producing method as claimed in claim 1 wherein when water vapour containing air is to be sucked from land area near hills/mountains, a platform (B) is built on land (A) on which are assembled the inlet (C) of the suction pipes along with the A.C./D.C. blowers with motors (D) which increase the amount of air containing water vapour being sucked in the inlet of the suction pipes (C) at high pressure or low pressure;
wherein the outlet pipes (E) are supported on the hill/mountain (F) and travel to the top of the hill/mountain (F) throughout its height;
wherein the outlet pipes (E) containing the air containing water vapour, may travel over or under the surface of the hill/mountain;
wherein a platform (G) is built on the top of the hill/mountain (F) on which the outlet pipe is brought;
wherein the outlet of the outlet pipe (H) stands on top of the platform (G) to which is joined the air mixer unit (I) with the help of the flexible pipe (J), which flexible pipes (J) is made of lightweight pressurized material;
wherein air containing water vapour sucked in through the inlet of the suction pipes (C) passes through the outlet pipes and the flexible pipes (J) and enters the air mixer unit (I) which has holes on its surface;
wherein cold air from the atmosphere enters the air mixer unit (I) through the holes and mixes with the air containing water vapour, condensing it to form water droplets which fall out from the air mixer (I) towards the ground in the form of artificial rain; and
wherein the air mixer (I) is connected to a helicopter (L) with the help of a rope (K) to station the flexible pipe (J) and air mixer (I) assembly at a position where rainfall is desired.

4. The artificial rain producing method as claimed in claim 1 wherein when water vapour containing air is to be sucked from land region, platform (B) is built on land (A) on which are assembled the inlet (C) of the suction pipes along with the A.C./D.C. blowers with motors (D) which increase the amount of air containing water vapour being sucked in the inlet of the suction pipes (C) at high pressure or low pressure;
wherein the outlet pipes (E) containing the air containing water vapour passes through the high stand on the platform (B);
wherein the outlet pipe (E) is joined to the air mixer unit (I) with the help of the flexible pipe (F), which flexible pipes (F) is made of lightweight pressurized material;
wherein air containing water vapour sucked in through the inlet of the suction pipes (C) passes through the outlet pipes and the flexible pipes (F) and enters the air mixer unit (I) which has holes on its surface;
wherein cold air from the atmosphere enters the air mixer unit (I) through the holes and mixes with the air containing water vapour, condensing it to form water droplets which fall out from the air mixer (I) towards the ground in the form of artificial rain; and
wherein the air mixer (I) is connected to a helicopter (H) with the help of a rope (G) to station the flexible pipe (F) and air mixer (I) assembly at a position where rainfall is desired.

5. (canceled)

6. The artificial rain producing method as claimed in claim 1 wherein the air mixer unit (A), is connected to the outlet of the flexible pipes with the inlet connection (B);
wherein the air containing water vapour sucked in from below, passes through the main outlet pipe (C) of the air mixer;
wherein the main outlet pipe (C) of the air mixer is joined to the sub-joint pipes (D) of the air mixer (A) which sub-joint pipes (D) has mini sub-joint parts (E) as its parts;
wherein the sub-joint pipes (D) and the mini sub-joint pipes (E) have holes on their surfaces through which air from the outer atmosphere enters the air mixer (A);
wherein the cold air from the outer atmosphere mixes with the air containing water vapour brought up from the surface of the earth in the air mixer (A), condenses it and flows out of the complete arrangement through the air mixer outlet (F) as water droplets and falls on the earth's surface in the form of artificial rain; and
wherein the air mixer (A) has various supports (G) at various locations on its main pipe for connecting the air mixer with the helicopter with ropes.

7. The artificial rain producing method as claimed in claim 6 wherein the air mixer is made of light weight P.V.C. material and more than one air mixers can be fitted to each flexible pipe according to the requirement.
